(19) United States
(12) Patent Application Publication
(10) Pub. No.: US 2006/0164860 A1
(43) Pub. Date: Jul. 27, 2006

(54) Liquid crystal display device

(75) Inventors: Yuki Muraoka, Tottori-shi (JP); Toyohiro Sakai, Hzumino-shi (JP); Junya Mita, Tottori-shi (JP); Naohiro Idenishi, Tottori-shi (JP); Hiroki Sakemoto, Tottori-shi (JP)

Correspondence Address: MCDERMOTT WILL & EMERY LLP, 600 13TH STREET, N.W., WASHINGTON, DC, 20005-3096, US

(73) Assignee: SANYO EPSON IMAGING DEVICES CORP.

(21) Appl. No.: 11/329,094

(22) Filed: Jan. 11, 2006

(30) Foreign Application Priority Data
Jan. 26, 2005 (JP) 2005-17876(P)
Jan. 26, 2005 (JP) 2005-17877(P)

(51) Int. Cl. G02F 1/1335; F21V 9/14

(52) U.S. Cl. 362/607; 362/561; 362/19

(57) ABSTRACT

A liquid crystal display device includes a light source and a light guide plate, and further includes, laid successively on top of the light guide plate, a diffusive sheet, a first and a second prism sheet having prism ridges thereof aligned in mutually perpendicular directions, a lower polarizing plate, a liquid crystal cell, and an upper polarizing plate. The first and second prism sheet has the prism ridges thereof aligned in a direction parallel or perpendicular to the row direction of the pixels. The lower polarizing plate has, laid successively downward below the liquid crystal cell, a first adhesive layer, a first transparent film, a polarizing film, and a second transparent film. The first adhesive layer contains a light-diffusing material.

### BACKGROUND OF THE INVENTION

1. Field of the Invention

The present invention relates to a liquid crystal display device, and more particularly to a liquid crystal display device that produces reduced moiré fringes even when provided with a prism sheet having prisms whose ridges are aligned parallel or perpendicular to the row direction of a liquid crystal cell.

2. Description of Related Art

A transmissive liquid crystal display device has various optical sheets, such as a diffusive sheet, a lens sheet, a prism sheet, and a polarizing film, laid between a liquid crystal cell and a backlight. An example of such a liquid crystal display device is seen in Japanese Patent Application Laid-open No. H11-52372 (in particular, in the claims, paragraphs [0017] to [0027], and FIGS. 1 and 2).

A prism sheet is used to condense the light from the backlight in the direction perpendicular to (at zero degrees to a line normal to) the light-exit surface of a light guide plate, with a view to increasing the front brightness of the liquid crystal cell. FIG. 7 shows a prism sheet 50 formed of a transparent sheet whose front surface 51 is formed into a prism surface having fine prisms whereas its back surface 52 is smooth. The prism surface, that is, the front surface of the prism sheet 50, has a large number of V-shaped grooves 53 and inverted-V-shaped ridges 54 formed parallel to one another at a fixed pitch “p.” An example of such a prism sheet is seen in Japanese Patent Application Laid-open No. H8-68997 (in particular, in the claims, paragraphs [0028] to [0030] and [0061] to [0075], and FIGS. 1to 6).

In general, in an active-matrix liquid crystal cell, as shown in FIG. 8, the R, G, and B (red, green, and blue) pixels thereof are each rectangular, and a large number of them are arrayed at a fixed pitch cyclically in the row and column directions of the pixels.

Thus, when a prism sheet is placed between the liquid crystal cell and a backlight, if, as shown in FIG. 9A, the prism sheet is so placed that the R, G, and B pixels arrayed at a fixed pitch in the liquid crystal cell in the row and column directions thereof are nearly parallel to the V-shaped grooves or the inverted-V-shaped ridges 54 (in FIGS. 9A and 9B, the V-shaped grooves are omitted) formed at a fixed pitch in large numbers in the prism sheet, the liquid crystal cell and the prism sheet interfere with each other to produce moiré fringes (interference fringes), which appear extremely obtrusive. To prevent this, a prism sheet is used in which, as shown in FIG. 9B, the ridges 54 of the prisms are aligned in a direction inclined at a certain angle θ with respect to the row direction of the pixels so as not to be parallel or perpendicular thereto; that is, in this prism sheet, the edges thereof is inclined at the angle θ with respect to the ridges 54 of the prisms.

As the angle θ gradually increases from zero, proportionally the interval of the moiré fringes gradually decreases, until eventually it becomes so small that the human eye can no longer recognize it, making moiré fringes practically invisible.

Here, inclining the direction of the array of the pixels of the liquid crystal cell and inclining the direction of the ridges of the prism sheet both produce the same effect. However, since the pixels of a liquid crystal cell are generally arrayed cyclically in the row and column directions on the substrate of the liquid crystal cell, and since inclining the direction of the ridges of the prism sheet is generally easier than inclining the direction of the array of the pixels of the liquid crystal cell, it is common to use a prism sheet whose ridges are at about 45 degrees to the edges of the prism sheet. In particular, in liquid crystal display devices for use in cellular phones and personal computers, to obtain high front brightness, and to obtain a narrow viewing angle to prevent view from people around, two prism sheets are used in combination, with the ridges of one aligned perpendicular to the ridges of the other.

However, using a prism sheet whose ridges are inclined at angle θ with respect to the edges thereof as described above involves the following inconveniences. Specifically, such a prism sheet is usually manufactured by first forming a master sheet having prisms without inclination, that is, in the vertical or horizontal direction, and then cutting it, with a die, in a direction inclined at angle 0 to obtain individual prism sheets. Thus, near the edges of the master sheet, it is impossible to obtain rectangular prism sheets. This leaves an unduly large part of the master sheet unused, increasing the cost of the prism sheets obtained therefrom.

Moreover, since such a prism sheet is placed relative to a liquid crystal cell so that the ridges of the former are inclined with respect to the direction in which the pixels of the latter are arrayed, the ridges obliquely cut the light-transmitting parts of the pixels, resulting in lower brightness.

On the other hand, by using a prism sheet with no-inclination prism ridges, that is, parallel or perpendicular to the edges thereof, it is certainly possible to overcome the above-mentioned inconveniences of higher cost and lower brightness. However, the row direction of the pixels is now nearly parallel or perpendicular to the prism ridges of the prism sheet, and thus the liquid crystal cell and the prism sheet interfere with each other to produce moire fringes, making it essential to take some measures against moiré fringes.

### SUMMARY OF THE INVENTION

The present invention has been made to overcome the conventionally encountered inconveniences discussed above. It is therefore an object of the present invention to provide a liquid crystal display device that produces inconspicuous moiré fringes even when provided with a prism sheet having prisms whose ridges are aligned parallel or perpendicular to the row direction of pixels.

To achieve the above object, according to one aspect of the present invention, a liquid crystal display device includes a light source and a light guide plate that takes in light from the light source, and further includes, laid successively on top of the light guide plate, a diffusive sheet, a prism sheet, a lower polarizing plate, a liquid crystal cell having a plurality of pixels arrayed in row and column directions, and an upper polarizing plate. Here, the prism sheet has the prism ridges thereof aligned in a direction parallel or perpendicular to the row direction of the pixels. Moreover, the lower polarizing plate has, laid successively downward below the liquid crystal cell, a first adhesive layer, a first transparent film, a polarizing film, and a second transparent film. Furthermore, the first adhesive layer contains a light-diffusing material.

With this structure, the use of the prism sheet having the prism ridges thereof aligned in a direction parallel or perpendicular to the row direction of the pixels offers the following advantages. First, a prism sheet can be used that has been cut out of a master sheet in an economical way so that no part thereof is left unused. This helps reduce cost. Second, the light-diffusing material contained in the first adhesive layer permits high dispersion of light. This makes the inevitably produced moiré fringes more difficult to recognize. Third, the prism ridges are not inclined with respect to the direction of the array of the pixels of the liquid crystal cell. This helps increase the brightness of the liquid crystal display device. Furthermore, the use of a single prism sheet makes it possible to realize a liquid crystal display device suitable for use in wide-viewing-angle monitors and televisions.

According to the present invention, in the liquid crystal display device structured as described above, the prism sheet is composed of two prism sheets having the prism ridges thereof aligned in mutually perpendicular directions. With this structure, it is possible to obtain higher brightness and a narrower viewing angle than when a single prism sheet is used, and thus it is possible to realize a liquid crystal display device suitable for use in cellular phones and personal computers, where prevention of view from people around is desirable.

According to the present invention, in the liquid crystal display device structured as described above, the lower polarizing plate has, laid below the second transparent film, a brightness enhancement film, with a second adhesive layer laid in between. With this structure, the brightness enhancement film reflects, of the visible light from the backlight, the light component so polarized as to be absorbed by the lower polarizing plate, and the thus reflected light is then again reflected by the reflective sheet and is thereby converted into light so polarized as not to be absorbed by the lower polarizing plate but to be reused. This increases the amount of light that is transmitted through the lower polarizing plate, and thus helps realize a liquid crystal display device that offers higher brightness.

According to the present invention, in the liquid crystal display device structured as described above, the brightness enhancement film has a hard coat applied to the side thereof making contact with the prism sheet. With this structure, even when the brightness enhancement film makes contact with the prism sheet, it is less likely to be scratched, and in addition it is less likely to develop a warp. Thus, it is possible to realize a liquid crystal display device free from degradation in image quality.

According to another aspect of the present invention, a liquid crystal display device includes a light source and a light guide plate that takes in light from the light source, and further includes, laid successively on top of the light guide plate, a diffusive sheet, a prism sheet, a lower polarizing plate, a liquid crystal cell having a plurality of pixels arrayed in row and column directions, and an upper polarizing plate. Here, the prism sheet has the prism ridges thereof aligned in a direction parallel or perpendicular to the row direction of the pixels. Moreover, the lower polarizing plate has, laid successively downward below the liquid crystal cell, a first adhesive layer, a first transparent film, a polarizing film, a second transparent film, a second adhesive layer, and a brightness enhancement film. Furthermore, the second adhesive layer contains a light-diffusing material.

With this structure, the light-diffusing material contained in the second adhesive layer permits high dispersion of light. This makes the inevitably produced moiré fringes more difficult to recognize.

According to the present invention, in the liquid crystal display device structured as described above, the prism sheet is composed of two prism sheets having the prism ridges thereof aligned in mutually perpendicular directions. With this structure, it is possible to obtain higher brightness and a narrower viewing angle than when a single prism sheet is used, and thus it is possible to realize a liquid crystal display device suitable for use in cellular phones and personal computers, where prevention of view from people around is desirable.

According to the present invention, in the liquid crystal display device structured as described above, not only does the second adhesive layer contain a light-diffusing material, the first adhesive layer also contains a light-diffusing material. With this structure, it is possible to realize a liquid crystal display device in which moiré fringes are more difficult to recognize.

According to the present invention, in the liquid crystal display device structured as described above, the brightness enhancement film has a hard coat applied to the side thereof making contact with the prism sheet. With this structure, even when the brightness enhancement film makes contact with the prism sheet, it is less likely to be scratched, and in addition it is less likely to develop a warp. Thus, it is possible to realize a liquid crystal display device free from degradation in image quality.

To achieve the above object, according to another aspect of the present invention, a liquid crystal display device includes, arranged successively upward, a backlight set, a lower polarizing plate, a liquid crystal cell having a plurality of pixels arranged in row and column directions, and an upper polarizing plate. Here, the backlight set includes a light source and a light guide plate that takes in light from the light source, and further includes, arranged successively on top of the light guide plate, a first diffusive sheet, a first prism sheet having the prism ridges thereof aligned in a direction parallel or perpendicular to the row direction of the pixels, and a second diffusive sheet. Moreover, the second diffusive sheet has a haze value of 60% or more but 80% or less.

The haze value (Th) is a quantity that indicates how hazy the interior or the surface of transparent plastic appears, and is also referred to as the “degree of haziness.” The haze value is calculated by measuring total light transmittance (Tt) and diffused light transmittance (Td), and then finding Th=(Td/Tt)×100(%).

With this structure, the use of the prism sheet having the prism ridges thereof aligned in a direction parallel or perpendicular to the row direction of the pixels permits the use of a prism sheet that has been cut out of a master sheet in an economical way so that no part thereof is left unused. This helps reduce cost.

Moreover, the use of the second diffusive sheet having a haze value of 60% or more but 80% or less, offering higher light diffusion efficiency than one conventionally used as the second diffusive sheet, permits the light that has entered the liquid crystal cell to be first diffused by the first diffusive sheet and then again diffused by the second diffusive sheet, so that the direction of incidence is highly diffused. Thus, the moiré fringes that are inevitably produced as a result of the use of the prism sheet having the prism ridges thereof aligned in a direction parallel or perpendicular to the row direction of the pixels are made more difficult to recognize. In addition, since the prism ridges are not inclined with respect to the direction of the array of the pixels of the liquid crystal cell, the liquid crystal display device offers higher brightness.

A haze value less than 60% leads to an insufficient light diffusion effect. This makes conspicuous the moiré fringes that are inevitably produced as a result of the use of the prism sheet having the prism ridges thereof aligned in a direction parallel or perpendicular to the row direction of the pixels. On the other hand, a haze value more than 80%, though leading to a strong light diffusion effect and making the moiré fringes inconspicuous, leads to low light transmittance, lowering the brightness of the liquid crystal display device.

According to the present invention, in the liquid crystal display device structured as described above, a second prism sheet is arranged between the first prism sheet and the first diffusive sheet, and the second prism sheet has the prism ridges thereof aligned perpendicularly to the prism ridges of the first prism sheet. With this structure, it is possible to obtain higher brightness and a narrower viewing angle in the liquid crystal display device than when a single prism sheet is used, and thus it is possible to realize a liquid crystal display device suitable for use in cellular phones and personal computers, where prevention of view from people around is desirable.

According to another aspect of the present invention, a liquid crystal display device includes, arranged successively upward, a backlight set, a lower polarizing plate, a liquid crystal cell having a plurality of pixels arranged in row and column directions, and an upper polarizing plate. Here, the backlight set includes a light source and a light guide plate that takes in light from the light source, and further includes, arranged successively on top of the light guide plate, a diffusive sheet, a first prism sheet having the prism ridges thereof aligned in a direction parallel or perpendicular to the row direction of the pixels, and an optical sheet. Moreover, the optical sheet contains a light-diffusing material.

With this structure, the use of the prism sheet having the prism ridges thereof aligned in a direction parallel or perpendicular to the row direction of the pixels permits the use of a prism sheet that has been cut out of a master sheet in an economical way so that no part thereof is left unused. This helps reduce cost. Moreover, the light-diffusing material contained in the optical sheet permits the light that has entered the liquid crystal cell to be first diffused by the diffusive sheet and then again diffused by the light-diffusing material contained in the optical sheet, so that the direction of incidence is highly diffused. Thus, the moiré fringes that are inevitably produced as a result of the use of the prism sheet having the prism ridges thereof aligned in a direction parallel or perpendicular to the row direction of the pixels are made more difficult to recognize. In addition, since the prism ridges are not inclined with respect to the direction of the array of the pixels of the liquid crystal cell, the liquid crystal display device offers higher brightness.

According to the present invention, in the liquid crystal display device structured as described above, the optical sheet has, provided on at least one side of a brightness enhancement film, a transparent sheet containing a light-diffusing material. The brightness enhancement film, on the principle of polarization by reflection, selectively reflects, of the visible light from the backlight, the light component so polarized as to be absorbed by the polarizing plate arranged below the liquid crystal cell so that this light component is reused over the entire viewing angle range of the liquid crystal cell. The transparent sheet containing a light-diffusing material may be provided on one or both surfaces of the brightness enhancement film.

With this structure, the brightness enhancement film reflects, of the visible light from the backlight, the light component so polarized as to be absorbed by the lower polarizing plate, and the thus reflected light is then again reflected by the reflective sheet and is thereby converted into light so polarized as not to be absorbed by the lower polarizing plate but to be reused. This increases the amount of light that is transmitted through the lower polarizing plate, and thus helps realize, even with a single prism sheet, a liquid crystal display device that offers higher brightness and a wide viewing angle, that is, one suitable for use in image display apparatuses such as monitors and televisions.

According to the present invention, in the liquid crystal display device structured as described above, a second prism sheet is arranged between the first prism sheet and the diffusive sheet, and the second prism sheet has the prism ridges thereof aligned perpendicularly to the prism ridges of the first prism sheet. With this structure, it is possible to obtain higher brightness and a narrower viewing angle in the liquid crystal display device than when a single prism sheet is used, and thus it is possible to realize a liquid crystal display device suitable for use in cellular phones and personal computers, where prevention of view from people around is desirable.

According to another aspect of the present invention, a liquid crystal display device includes, arranged successively upward, a backlight set, a lower polarizing plate, a liquid crystal cell having a plurality of pixels arranged in row and column directions, and an upper polarizing plate. Here, the backlight set includes a light source and a light guide plate that takes in light from the light source, and further includes, arranged successively on top of the light guide plate, a diffusive sheet and a first prism sheet having the prism ridges thereof aligned in a direction parallel or perpendicular to the row direction of the pixels. Moreover, the diffusive sheet has, formed on the top surface of a transparent base sheet, a light diffusion layer containing transparent fine particles.

With this structure, the use of the prism sheet having the prism ridges thereof aligned in a direction parallel or perpendicular to the row direction of the pixels permits the use of a prism sheet that has been cut out of a master sheet in an economical way so that no part thereof is left unused. This helps reduce cost.

Moreover, the diffusive sheet, having formed on the top surface of the transparent base sheet the light diffusion layer containing transparent fine particles, offers high light transmittance combined with high light diffusion efficiency. This helps realize, even with a single prism sheet, a liquid crystal display device that offers a wide viewing angle and higher brightness. Thus, the moiré fringes that are inevitably produced as a result of the use of the prism sheet having the prism ridges thereof aligned in a direction parallel or perpendicular to the row direction of the pixels are made more difficult to recognize. In addition, since the prism ridges are not inclined with respect to the direction of the array of the pixels of the liquid crystal cell, the liquid crystal display device offers higher brightness.

According to the present invention, in the liquid crystal display device structured as described above, a second prism sheet is arranged between the first prism sheet and the diffusive sheet, and the second prism sheet has the prism ridges thereof aligned perpendicularly to the prism ridges of the first prism sheet. With this structure, it is possible to obtain higher brightness and a narrower viewing angle in the liquid crystal display device than when a single prism sheet is used, and thus it is possible to realize a liquid crystal display device suitable for use in cellular phones and personal computers, where prevention of view from people around is desirable.

### DESCRIPTION OF THE DRAWINGS

The above and other objects and features of the present invention will be made clearer by way of preferred embodiments described below with reference to the accompanying drawings, in which:

FIG. 1 is a vertical sectional view of the liquid crystal display device of a first embodiment of the present invention;

FIG. 2 is a vertical sectional view of the liquid crystal display device of a second embodiment of the present invention;

FIG. 3 is a vertical sectional view of the liquid crystal display device of a third embodiment of the present invention;

FIG. 4 is a vertical sectional view of the liquid crystal display device of a fourth embodiment of the present invention;

FIG. 5 is a vertical sectional view of the liquid crystal display device of a fifth embodiment of the present invention;

FIG. 6 is a vertical sectional view of the liquid crystal display device of a sixth embodiment of the present invention;

FIG. 7 is an enlarged vertical sectional view of a prism sheet;

FIG. 8 is an enlarged plan view of individual pixels of a liquid crystal cell;

FIG. 9A is a plan view illustrating the direction of the prism ridges of a prism sheet; and

FIG. 9B is another plan view illustrating the direction of the prism ridges of a prism sheet.

### DESCRIPTION OF THE PREFERRED EMBODIMENTS

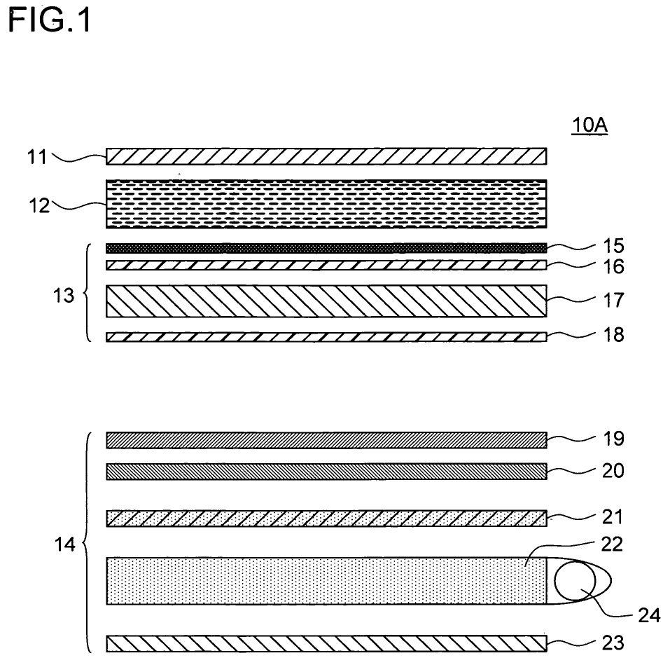

Hereinafter, by way of the embodiments shown in FIGS. 1 to 6, the best mode of carrying out the present invention will be described in detail. These embodiments deal with liquid crystal devices merely as examples to which the technical idea of the present invention is applied, and are therefore not meant to limit the way the present invention is practiced. The present invention thus permits many modifications and variations made within the scope of the technical idea thereof as set out in the appended claims.

### Embodiment 1

The liquid crystal display device 10A of a first embodiment of the present invention will now be described with reference to FIG. 1, which is a vertical sectional view thereof. The liquid crystal display device 10A of the first embodiment is composed roughly of, laid successively downward, an upper polarizing plate 11, a liquid crystal cell 12, a lower polarizing plate 13, and a backlight set 14. The lower polarizing plate 13 is composed of, laid successively downward below the liquid crystal cell 12 and integrated together, a first adhesive layer 15, a first transparent film 16, a polarizing film 17, and a second transparent film 18. The polarizing film 17 is formed of a polarizing base material, such as polyvinyl alcohol, containing a polarizing element material, such as iodine or dichromatic dye. The first and second transparent films 16 and 18 is formed of transparent triacetylcellulose, and serve to protect the polarizing film 17. The first adhesive layer 15 bonds the first transparent film 16, the polarizing film 17, and the second transparent film 18 to the lower substrate of the liquid crystal cell 12.

The backlight set 14 has, arranged successively downward below the liquid crystal cell 12, a first and a second prism sheet 19 and 20 having the prism ridges thereof aligned in mutually perpendicular directions, a diffusive sheet 21, a light guide plate 22, and a reflective sheet 23. Along an edge of the light guide plate 22, a backlight 24 is arranged that is built with a tubular cold cathode tube or a light-emitting diode.

For easy understanding, in FIG. 1, the first and second prism sheets 19 and 20, the diffusive sheet 21, the light guide plate 22, and the reflective sheet 23 are shown as being located apart from one another. In reality, it should be noted, those components are placed in contact with one another when the liquid crystal display device 10A is assembled into an unillustrated frame member.

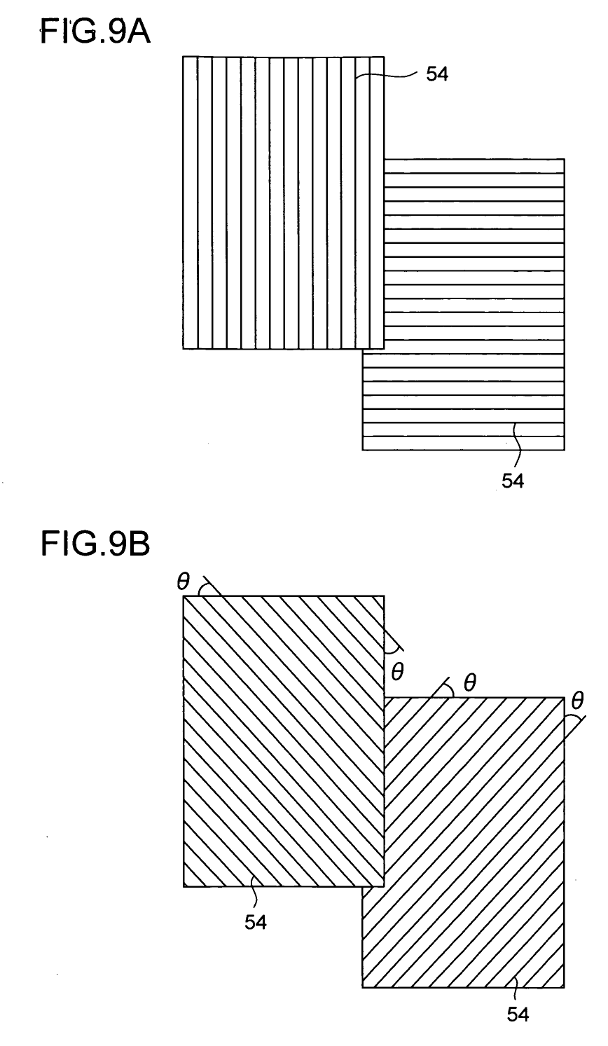

In the first embodiment, used as the first and second prism sheets 19 and 20 are those having, as shown in FIG. 9A, the prism ridges thereof aligned in a direction parallel or perpendicular to the edges thereof. Moreover, the first adhesive layer 15 included in the lower polarizing plate 13 contains a light-diffusing material in the form of fine transparent particles.

With a prior-art structure, using prism sheets having the prism ridges thereof aligned in a direction parallel or perpendicular to the edges thereof as described above results in the prism edges being aligned in a direction parallel or perpendicular to the row direction of the pixels. This produces conspicuous moiré fringes. By contrast, in the first embodiment, since the first adhesive layer 15 contains a light-diffusing material, the direction of incidence of the light that enters the liquid crystal cell 12 is less regular. This contributes to inconspicuous moiré fringes.

Moreover, since the prism sheets have the prism ridges thereof aligned in a direction parallel or perpendicular to the edges thereof, they can be cut out of a master sheet in an economical way so that no part thereof is left unused. Thus, the liquid crystal display device 10A of the first embodiment produces reduced moiré fringes despite using inexpensive prism sheets.

In the first embodiment, two prism sheets 19 and 20 are used; alternatively, only one prism sheet may be used. Using two prism sheets 19 and 20 brings higher brightness and a narrower viewing angle than using a single prism sheet. This makes it possible to realize a liquid crystal display device suitable for use in cellular phones and personal computers, where prevention of view from people around is desirable. By contrast, using a single prism sheet brings a wider viewing angle, though with lower brightness, than using two prism sheets. This is suitable in image display apparatuses such as monitors and televisions.

### Embodiment 2

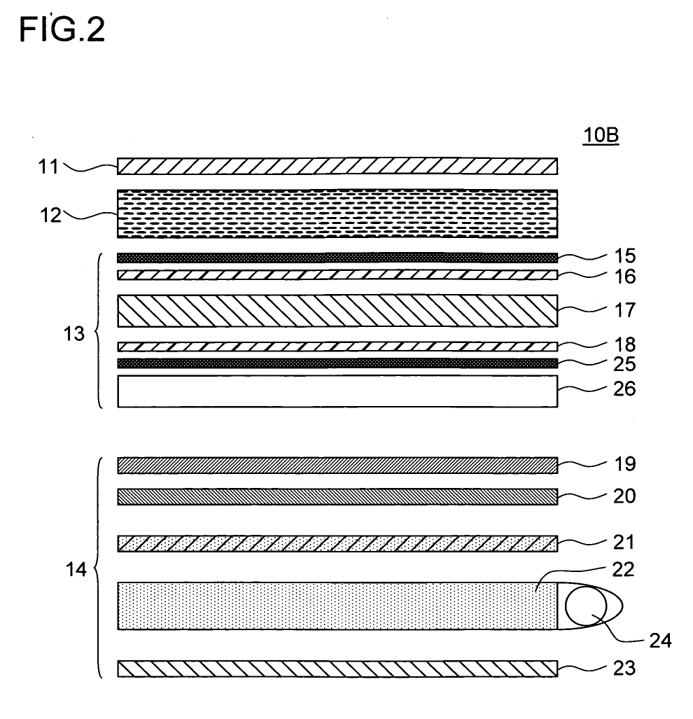

The liquid crystal display device 10B of a second embodiment of the present invention will now be described with reference to FIG. 2, which is a vertical sectional view thereof. In FIG. 2, such components as are found also in the liquid crystal display device 10A of the first embodiment are identified with common reference numerals, and no detailed explanation thereof will be repeated.

The liquid crystal display device 10B of the second embodiment differs from the liquid crystal display device 10A of the first embodiment in the following respects: in the lower polarizing plate 13, a brightness enhancement film 26 is laid on the side of the second transparent film 18 facing the first prism sheet 19, with a second adhesive layer 25 laid in between; thus, the brightness enhancement film 26 and the second transparent film 18 are bonded together by the second adhesive layer 25 laid therebetween. In other respects, the structure here is the same as that of the liquid crystal display device 10A of the first embodiment.

On the principle of polarization by reflection, the brightness enhancement film 26 selectively reflects, of the visible light from the backlight 24, the light component so polarized as to be absorbed by the polarizing film 17 arranged below the liquid crystal cell 12 so that this light component is again reflected by the reflective sheet 23 and is thereby converted into light so polarized as not to be absorbed by the polarizing film 17 but to be reused. Used as the brightness enhancement film 26 is, for example, one commercially available under the product name “DBEF” (manufactured by Sumitomo 3M Limited). Using the brightness enhancement film 26 helps realize a liquid crystal display device 10B that offers higher brightness while achieving advantages comparable with those achieved with the liquid crystal display device 10A of the first embodiment.

In the second embodiment, the lower polarizing plate 13 has, laid successively downward below the liquid crystal cell 12, a first adhesive layer 15, a first transparent film 16, a polarizing film 17, a second transparent film 18, a second adhesive layer 25, and a brightness enhancement film 26. Used as the brightness enhancement film 26 is one commercially available under the product name “DBEF-P2” (manufactured by Sumitomo 3M Limited), and used as the first adhesive layer 15 is one containing a light-diffusing material. In the second embodiment, as in the first embodiment, the number of prism sheets used may be two or one.

### Embodiment 3

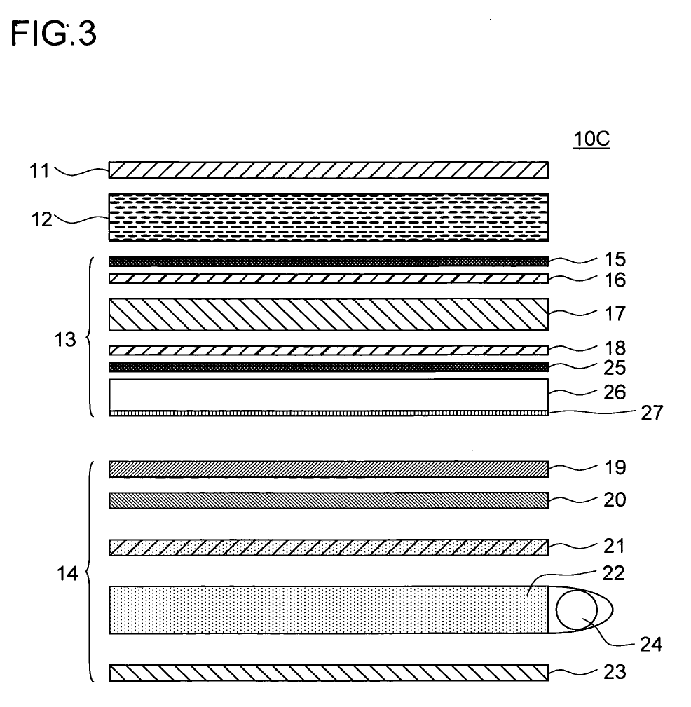

The liquid crystal display device 10C of a third embodiment of the present invention will now be described with reference to FIG. 3, which is a vertical sectional view thereof. In FIG. 3, such components as are found also in the liquid crystal display devices 10A and 10B of the first and second embodiments are identified with common reference numerals, and no detailed explanation thereof will be repeated.

The liquid crystal display device 10C of the third embodiment differs from the liquid crystal display device 10B of the second embodiment in the following respects: a hard coat layer 27 is laid on the side of the brightness enhancement film 26 facing the first prism sheet 19. In other respects, the structure here is the same as that of the liquid crystal display device 10B of the second embodiment.

The first prism sheet 19 has prism ridges. When the brightness enhancement film 26 deforms or moves because of temperature variation or the like, it may make contact with the prism ridges of the first prism sheet 19 and thereby be scratched and degraded. Here, however, the hard coat layer 27 laid on the side of the brightness enhancement film 26 facing the first prism sheet 19 makes the brightness enhancement film 26 less likely to be scratched even when it makes contact with the first prism sheet 19, and less likely to develop a warp. This makes it possible to realize a liquid crystal display device 10C that is free from degradation in image quality while achieving advantages comparable with those achieved with the liquid crystal display device 10B of the second embodiment.

The lower polarizing plate 13 has, laid successively downward, a first adhesive layer 15, a first transparent film 16, a polarizing film 17, a second transparent film 18, a second adhesive layer 25, a brightness enhancement film 26, and a hard coat layer 27. Used as the brightness enhancement film 26 having the hard coat layer 27 laid thereon is one commercially available under the product name “DBEF-P2-HC” (manufactured by Sumitomo 3M Limited), and used as the first adhesive layer 15 is one containing a light-diffusing material.

In the third embodiment, as in the first embodiment, the number of prism sheets used may be two or one.

In the liquid crystal display devices 10B and 10C of the second and third embodiments described above, the first adhesive layer 15 alone contains a light-diffusing material. Instead, the second adhesive layer 25 may contain a light-diffusing material. Alternatively, both the first adhesive layer 15 and second adhesive layer 25 may contain a light-diffusing material. Adding a light-diffusing material to the second adhesive layer 25 instead of the first adhesive layer 15 achieves advantages comparable with adding a light-diffusing material to the first adhesive layer. Adding a light-diffusing material to both the first adhesive layer 15 and the first adhesive layer 15 permits light to be diffused satisfactorily with respect to the illuminated surface of the liquid crystal cell 12 over the entire area thereof. This makes the moiré fringes quite inconspicuous even in a case where a prism sheet is used that has the prism ridges thereof aligned in a direction parallel or perpendicular to the row direction of the pixels.

### Embodiment 4

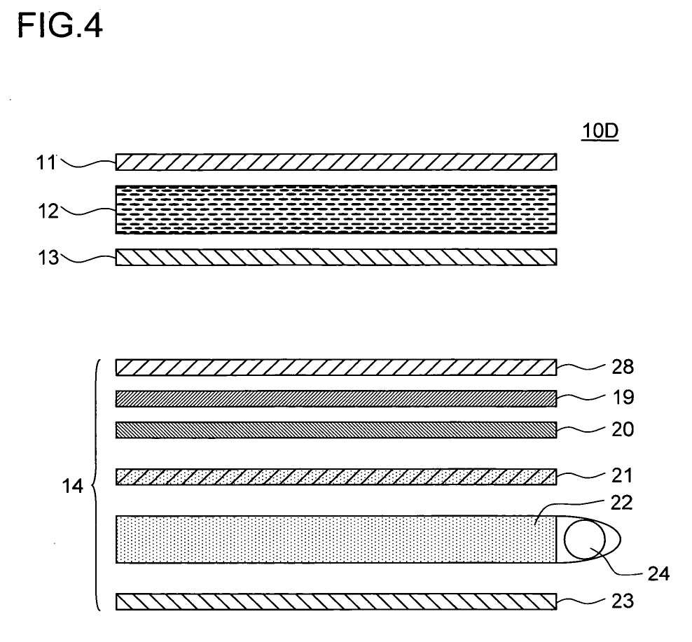

The liquid crystal display device 10D of a fourth embodiment of the present invention will now be described with reference to FIG. 4, which is a vertical sectional view thereof. In FIG. 4, such components as are found also in the liquid crystal display devices 10A, 10B, and 10C of the first to third embodiments are identified with common reference numerals, and no detailed explanation thereof will be repeated.

The liquid crystal display device 10D of the fourth embodiment is composed roughly of, laid successively downward, an upper polarizing plate 11, a liquid crystal cell 12, a lower polarizing plate 13, and a backlight set 14. The upper and lower polarizing plates 11 and 13 are shown as being located apart from the liquid crystal cell 12; in reality, it should be noted, they are in close contact with both surfaces, respectively, of the liquid crystal cell 12.

On the other hand, the backlight set 14 has, arranged successively downward below the liquid crystal cell 12, a second diffusive sheet 28, a fist and second prism sheets 19 and 20 having the prism ridges thereof aligned in mutually perpendicular directions, a first diffusive sheet 21, a light guide plate 22, and a reflective sheet 23. Along an edge of the light guide plate 22, a backlight 24 is arranged that is built with a tubular cold cathode tube or a light-emitting diode.

For easy understanding, in FIG. 4, the second diffusive sheet 28, the first and second prism sheets 19 and 20, the first diffusive sheet 21, the light guide plate 22, and the reflective sheet 23 are shown as being located apart from one another. In reality, it should be noted, those components are placed in contact with one another when the liquid crystal display device 10D is assembled into an unillustrated frame member.

In the fourth embodiment, used as the first and second prism sheets 19 and 20 are those having, as shown in FIG. 9A, the prism ridges thereof aligned in a direction parallel or perpendicular to the edges thereof. Moreover, used as the second diffusive sheet 28 is one having a haze value of 60% or more but 80% or less.

With a prior-art structure, using prism sheets having the prism ridges thereof aligned in a direction parallel or perpendicular to the edges thereof as described above results in the prism edges being aligned in a direction parallel or perpendicular to the row direction of the pixels. This produces conspicuous moiré fringes. By contrast, in the fourth embodiment, because of the use of the second diffusive sheet 28 having a haze value of 60% or more but 80% or less, offering higher light diffusion efficiency than one conventionally used as the first diffusive sheet, and because the light that has entered the liquid crystal cell 12 is first diffused by the first diffusive sheet 21 and is then again diffused by the second diffusive sheet 28 greatly, the direction of incidence is highly diffused, making the moire fringes inconspicuous.

Giving the second diffusive sheet 28 a haze value less than 60% leads to an insufficient light diffusion effect, making the moiré fringes conspicuous. Giving the second diffusive sheet 28 a haze value more than 80% produces a strong light-diffusion effect, making the moiré fringes inconspicuous, but simultaneously leads to lower light transmittance, lowering the brightness of the liquid crystal display device. Moreover, since the prism sheets have the prism ridges thereof aligned in a direction parallel or perpendicular to the edges thereof, they can be cut out of a master sheet in an economical way so that no part thereof is left unused. Thus, the liquid crystal display device 10D of the fourth embodiment produces reduced moiré fringes despite using inexpensive prism sheets.

In the fourth embodiment, two prism sheets are used; alternatively, only one prism sheet may be used. Using two prism sheets brings higher brightness and a narrower viewing angle than using a single prism sheet. This makes it possible to realize a liquid crystal display device suitable for use in cellular phones and personal computers, where prevention of view from people around is desirable. By contrast, using a single prism sheet brings a wider viewing angle, though with lower brightness, than using two prism sheets. This is suitable in image display apparatuses such as monitors and televisions.

### Embodiment 5

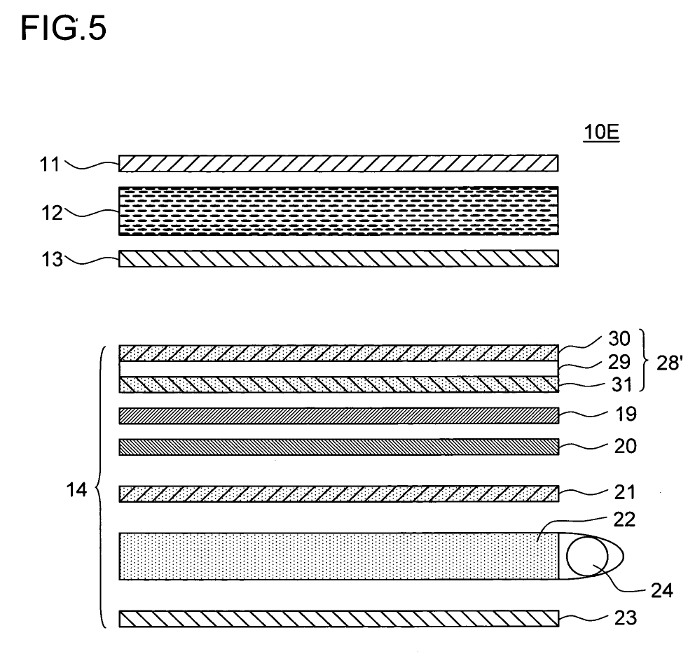

The liquid crystal display device 10E of a fifth embodiment of the present invention will now be described with reference to FIG. 5, which is a vertical sectional view thereof. In FIG. 5, such components as are found also in the liquid crystal display device 10D of the fourth embodiment are identified with common reference numerals, and no detailed explanation thereof will be repeated.

The liquid crystal display device 10E of the fifth embodiment differs from the liquid crystal display device 10D of the fourth embodiment in the following respects: in the backlight set 14, instead of the second diffusive sheet 28, an optical sheet 28′ is used that has, laid on both surfaces of a brightness enhancement film 29, transparent sheets 30 and 31 containing a light-diffusing material. In other respects, the structure here is the same as that of the liquid crystal display device 10D of the fourth embodiment.

Used as the brightness enhancement film 29 is, for example, one commercially available and widely known under the product name “DBEF” (manufactured by Sumitomo 3M Limited). In the fifth embodiment, on the surfaces of the brightness enhancement film 29, the transparent sheets 30 and 31 containing a light-diffusing material are laid. As the optical sheet 28′ structured in that way, one commercially available under the produce name DBEF-D400 (manufactured by Sumitomo 3M Limited) can be used as it is.

The use of the optical sheet 28′ permits the brightness enhancement film 29 to reflect, of the visible light from the backlight, the light component so polarized as to be absorbed by the lower polarizing plate 13. The thus reflected light component is again reflected by the reflective sheet 23 and is thereby converted into light so polarized as not to be absorbed by the lower polarizing plate 13 but to be reused. This increases the amount of light that is transmitted through the lower polarizing plate 13. Moreover, the transparent sheets 30 and 31 containing a light-diffusing material more highly diffuse the light that enters the liquid crystal cell 12.

Thus, with the liquid crystal display device 10E of the fifth embodiment, even when prism sheets are used that have the prism ridges thereof aligned in a direction parallel or perpendicular to the edges thereof, due to the brightness enhancement effect and light diffusion effect of the optical sheet 28′, it is possible to realize a liquid crystal display device 10E that offers higher brightness while achieving advantages comparable with those achieved with the liquid crystal display device 10D of the fourth embodiment. The transparent sheets 30 and 31 may be provided on only one surface of the brightness enhancement film 29, or on both surfaces thereof. In the fifth embodiment, two prism sheets are used; alternatively, as in the fourth embodiment, only one prism sheet may be used.

### Embodiment 6

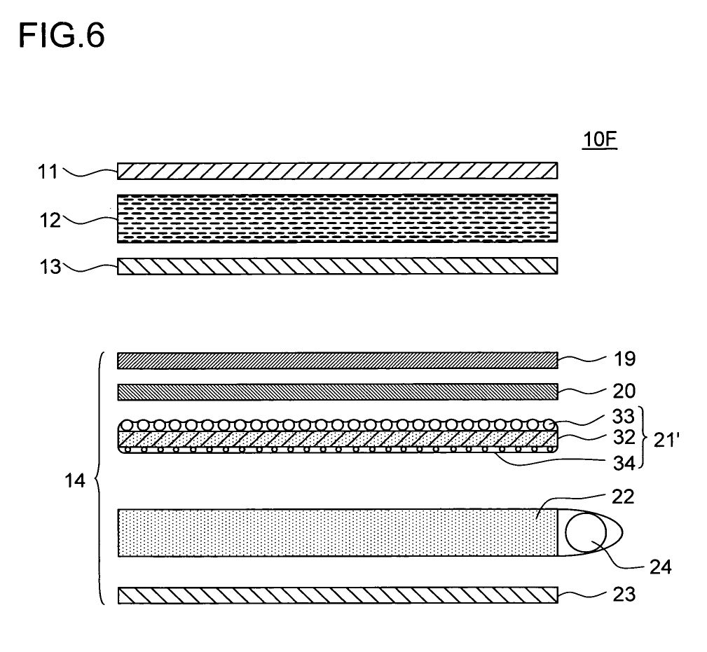

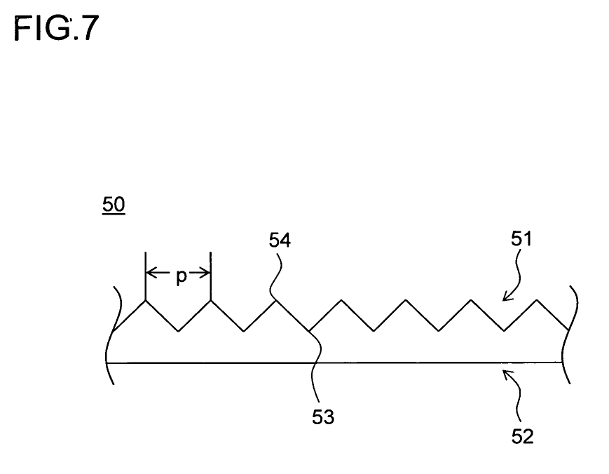

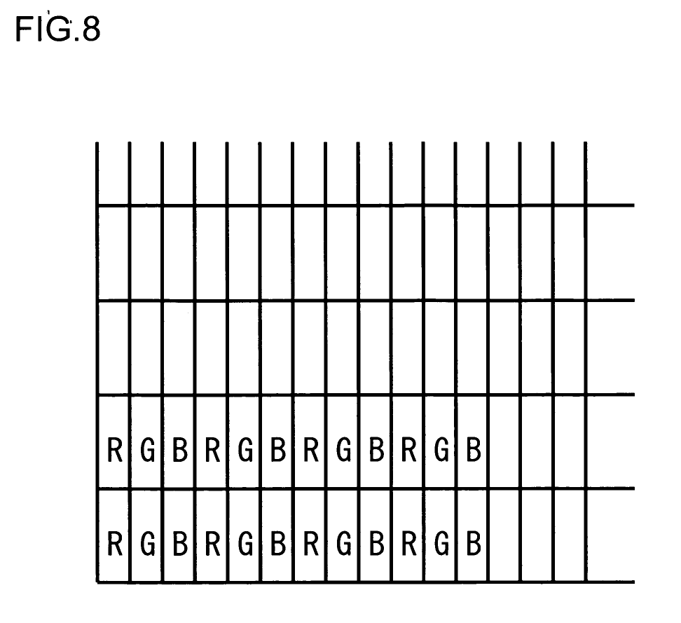

The liquid crystal display device 10F of a sixth embodiment of the present invention will now be described with reference to FIG. 6, which is a vertical sectional view thereof. In FIG. 6, such components as are found also in the liquid crystal display devices 10D and 10E of the fourth and fifth embodiments are identified with common reference numerals, and no detailed explanation thereof will be repeated.

The liquid crystal display device 10F of the sixth embodiment differs from the liquid crystal display device 10E of the fifth embodiment in the following respects: the optical sheet 28′ used in the liquid crystal display device 10E of the fifth embodiment is not used; and, instead of the diffusive sheet 21, a high-brightness diffusive sheet 21′ is used. In other respects, the structure here is the same as that of the liquid crystal display device 10E of the fifth embodiment.

The high-brightness diffusive sheet 21′ has, formed on one surface of a transparent base sheet 32, a light diffusion layer 33 containing fine transparent particles. Used as the high-brightness diffusive sheet 21′ here is commercially available one having, laid on the other surface of the transparent base sheet 32, a back coat layer 34 exerting an antisticking or antistatic effect, for example, one appropriately selected from among those belonging to the “Opalus BS” series line of products (manufactured by Keiwa Inc.) or the “Light Up GM3” series line of products (manufactured by Kimoto Co., Ltd.). The high-brightness diffusive sheet 21′, as compared with a common diffusive sheet conventionally used, offers higher total light transmittance and produces highly diffused light.

Thus, with the liquid crystal display device 10F of the sixth embodiment, even when prism sheets are used that have the prism ridges thereof aligned in a direction parallel or perpendicular to the edges thereof, due to the brightness enhancement effect and light diffusion effect of the high-brightness diffusive sheet 21′, it is possible to realize a liquid crystal display device 10F that offers higher brightness while achieving advantages comparable with those achieved with the liquid crystal display device 10D of the fourth embodiment. Here, the light diffusion layer 33 containing fine transparent particles may be provided on only one surface of the transparent base sheet 32, or on both surfaces thereof. In the sixth embodiment, two prism sheets are used; alternatively, as in the fifth embodiment, only one prism sheet may be used.

It should be understood that the present invention may be carried out in any manner other than specifically described above as embodiments, and many variations and modifications are possible within the spirit of the present invention.

What is claimed is:

1. A liquid crystal display device including a light source and a light guide plate that takes in light from the light source, the liquid crystal display device further including, laid successively on top of the light guide plate, a diffusive sheet, a prism sheet, a lower polarizing plate, a liquid crystal cell having a plurality of pixels arrayed in row and column directions, and an upper polarizing plate, wherein
the prism sheet has prism ridges thereof aligned in a direction parallel or perpendicular to a row direction of the pixels,
the lower polarizing plate has, laid successively downward below the liquid crystal cell, a first adhesive layer, a first transparent film, a polarizing film, and a second transparent film, and
the first adhesive layer contains a light-diffusing material.

2. The liquid crystal display device of claim 1, wherein
the prism sheet is composed of two prism sheets having prism ridges thereof aligned in mutually perpendicular directions.

3. The liquid crystal display device of claim 1, wherein
the lower polarizing plate has, laid below the second transparent film, a brightness enhancement film, with a second adhesive layer laid in between.

4. The liquid crystal display device of claim 3, wherein
the brightness enhancement film has a hard coat applied to a side thereof making contact with the prism sheet.

5. A liquid crystal display device including a light source and a light guide plate that takes in light from the light source, the liquid crystal display device further including, laid successively on top of the light guide plate, a diffusive sheet, a prism sheet, a lower polarizing plate, a liquid crystal cell having a plurality of pixels arrayed in row and column directions, and an upper polarizing plate, wherein
the prism sheet has prism ridges thereof aligned in a direction parallel or perpendicular to a row direction of the pixels,
the lower polarizing plate has, laid successively downward below the liquid crystal cell, a first adhesive layer, a first transparent film, a polarizing film, a second transparent film, a second adhesive layer, and a brightness enhancement film, and
the second adhesive layer contains a light-diffusing material.

6. The liquid crystal display device of claim 5, wherein
the prism sheet is composed of two prism sheets having prism ridges thereof aligned in mutually perpendicular directions.

7. The liquid crystal display device of claim 5, wherein
the second adhesive layer also contains a light-diffusing material.

8. The liquid crystal display device of claim 5, wherein
the brightness enhancement film has a hard coat applied to a side thereof making contact with the prism sheet.

9. A liquid crystal display device including, arranged successively upward, a backlight set, a lower polarizing plate, a liquid crystal cell having a plurality of pixels arranged in row and column directions, and an upper polarizing plate, wherein
the backlight set includes a light source and a light guide plate that takes in light from the light source, the backlight set further including, arranged successively on top of the light guide plate, a first diffusive sheet, a first prism sheet having prism ridges thereof aligned in a direction parallel or perpendicular to a row direction of the pixels, and a second diffusive sheet, and
the second diffusive sheet has a haze value of 60% or more but 80% or less.

10. The liquid crystal display device of claim 9, wherein
a second prism sheet is arranged between the first prism sheet and the first diffusive sheet, the second prism sheet having prism ridges thereof aligned perpendicularly to the prism ridges of the first prism sheet.

11. A liquid crystal display device including, arranged successively upward, a backlight set, a lower polarizing plate, a liquid crystal cell having a plurality of pixels arranged in row and column directions, and an upper polarizing plate, wherein
the backlight set includes a light source and a light guide plate that takes in light from the light source, the backlight set further including, arranged successively on top of the light guide plate, a diffusive sheet, a first prism sheet having prism ridges thereof aligned in a direction parallel or perpendicular to a row direction of the pixels, and an optical sheet, and
the optical sheet contains a light-diffusing material.

12. The liquid crystal display device of claim 11, wherein
the optical sheet has, provided on at least one surface of a brightness enhancement film, a transparent sheet containing a light-diffusing material.

13. The liquid crystal display device of claim 1 1, wherein
a second prism sheet is arranged between the first prism sheet and the diffusive sheet, the second prism sheet having prism ridges thereof aligned perpendicularly to the prism ridges of the first prism sheet.

14. A liquid crystal display device including, arranged successively upward, a backlight set, a lower polarizing plate, a liquid crystal cell having a plurality of pixels arranged in row and column directions, and an upper polarizing plate, wherein
the backlight set includes a light source and a light guide plate that takes in light from the light source, the backlight set further including, arranged successively on top of the light guide plate, a diffusive sheet and a first prism sheet having prism ridges thereof aligned in a direction parallel or perpendicular to a row direction of the pixels, and
the diffusive sheet has, formed on a top surface of a transparent base sheet, a light diffusion layer containing transparent fine particles.

15. The liquid crystal display device of claim 14, wherein
a second prism sheet is arranged between the first prism sheet and the diffusive sheet, the second prism sheet having prism ridges thereof aligned perpendicularly to the prism ridges of the first prism sheet.
